(19) United States
(12) Patent Application Publication
(10) Pub. No.: US 2025/0335937 A1
(43) Pub. Date: Oct. 30, 2025

(54) CONFORMITY-DRIVEN ADAPTIVE RESOURCE OPTIMIZATION FOR DYNAMIC ALLOCATION

(71) Applicant: Dell Products L.P., Round Rock, TX (US)

(72) Inventors: John Flume, La Marque, TX (US); Kailash Talreja, Mumbai (IN); Saurabh Jha, Austin, TX (US)

(21) Appl. No.: 18/644,269

(22) Filed: Apr. 24, 2024

(51) Int. Cl. G06Q 30/0202; G06Q 10/0631

(52) U.S. Cl. CPC G06Q 30/0202; G06Q 10/06315

(57) ABSTRACT

A method for managing order processing includes obtaining a time series dataset associated with the order processing for an order processing system, generating a forecasting model for the time series dataset using a data processing module, calculating a conformity score on the forecasting model to determine a dynamic resource allocation of the order processing system, performing an agent deployment for a plurality of agents of the order processing system based on the dynamic resource allocation, wherein the plurality of agents each provide services associated with order processing, perform a multi-parameter optimization of a set of parameters of the forecasting model based on the agent deployment to obtain an updated forecasting model, and generating a resource allocation output based on the updated forecasting model.

### BACKGROUND

Order processing and query incident management are branches of a corporate entity that manage the purchases between customers and the corporate entity. The corporate entity may manage the deployment of agents for the purposes of providing order processing services. The deployment of agents may involve the consumption of resources, so it may be beneficial to accurately deploy a proper number of agents based on an expected volume of orders to be processed.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention.

FIG. 2 shows a diagram of an order forecasting manager in accordance with one or more embodiments of the invention.

FIG. 3 shows a flowchart of a method of generating forecasting models in accordance with one or more embodiments of the invention.

FIG. 4 shows an example in accordance with one or more embodiments of the invention.

FIG. 5 shows a diagram of a computing device in accordance with one or more embodiments of the invention.

### DETAILED DESCRIPTION

Specific embodiments of the invention will now be described in detail with reference to the accompanying figures. In the following detailed description of the embodiments of the invention, numerous specific details are set forth in order to provide a more thorough understanding of one or more embodiments of the invention. However, it will be apparent to one of ordinary skill in the art that one or more embodiments of the invention may be practiced without these specific details. In other instances, well-known features have not been described in detail to avoid unnecessarily complicating the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In general, embodiments disclosed herein include methods and systems for managing order processing of a corporate entity. Embodiments disclosed herein include tracking the number of orders processed over a period of time for multiple epicenters (e.g., branches of the corporate entity), storing each of the tracked number of orders as a time series dataset. A processing of the set of time series datasets in accordance with one or more embodiments of the invention includes generating a forecasting model using a time series dataset, generating a conformity score for data points in the time series dataset to determine a conformity of the forecasting model. The forecasting models may be used for managing the resource distribution applied for order processing. For example, if the forecasting models specify increase in order volumes, the resource distribution may include increasing a number of agents deployed for the purposes of order processing. Further, if the forecasting models specify a relative decrease in order volumes, the resource distribution may include increasing a number of agents deployed for the purposes of order processing. The implementation of an agent deployment in accordance with the forecasting model is tracked and compared to an actual order processing volume. The parameters may be optimized based on the expected order volumes compared to actual order volumes and further based on the conformity scores for a given point in time.

The following describes various embodiments of the invention.

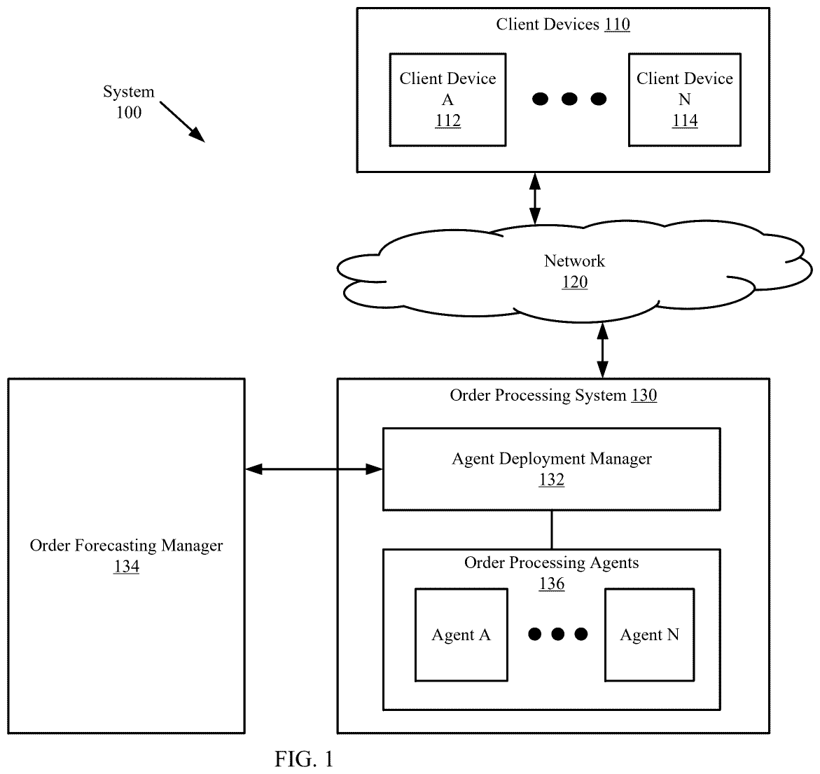

FIG. 1 shows a system in accordance with one or more embodiments of the invention. The system (100) includes any number of client devices (110), a network (120), an order processing system (130), and an order forecasting manager (134). The system (100) may include additional, fewer, and/or different components without departing from the scope of the invention. Each component may be operably connected to any of the other component via any combination of wired and/or wireless connections. Each component illustrated in FIG. 1 is discussed below.

In one or more embodiments of the invention, the order processing system (130) may provide computer-implemented services to users. The computer-implemented services may include deploying order processing agents (136) (also referred to as processing agents (136)) that aid in communicating with the client devices (110) to process orders for new products. Examples of computer-implemented services include transactions for purchasing the new products, customer support systems (such as online chat services), tracking and managing inventory, initiating shipping of products, order tracking, managing customer communication with the client devices (112, 114), and providing information to the client devices (110) that include information about previous orders, transaction information associated with current, past, or future orders, and/or any other information associated with the processing of one or more orders.

The volume of orders may impact the required number of order processing agents (136). In one or more embodiments, the processing of orders is performed using order processing agents (136) of the order processing system (130). The order processing agents (136) may each include functionality to communicate with the client devices (110) to provide the aforementioned services based on products offered by a corporate entity managing the order processing system (130).

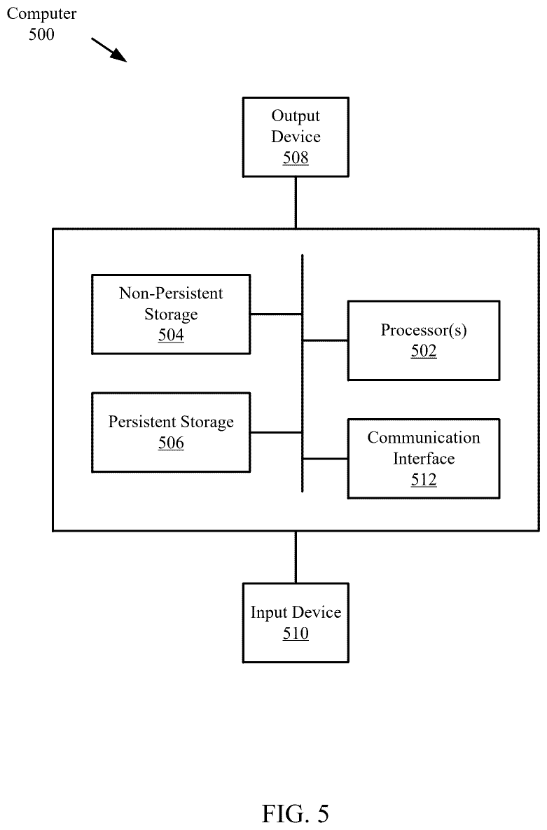

In one or more embodiments of the invention, the order processing system (130) (and/or any components illustrated within) may be implemented as one or more computing devices (e.g., 500, FIG. 5). A computing device may be, for example, a mobile phone, a tablet computer, a laptop computer, a desktop computer, a server, a sale terminal, a distributed computing system, or a cloud resource such as a transaction management unit. The computing device may include one or more processors, memory (e.g., RAM), and persistent storage (e.g., disk drives, SSDs, etc.). The computing device may include instructions, stored on the persistent storage, that when executed by the processor(s) of the computing device cause the computing device to perform the functionality of the order processing system (130) (and/or any components illustrated within) described throughout this present disclosure.

Alternatively, in one or more embodiments of the invention, the order processing system (130) (and/or any components illustrated within) may be implemented as logical devices. A logical device may utilize the computing resources of any number of computing devices to provide the functionality of the order processing system (130) (and/or any components illustrated within) described throughout this present disclosure.

In one or more embodiments, the deployment of the processing agents (136) is managed by an agent deployment manager (132). In one or more embodiments, the agent deployment manager (132) includes functionality for assigning each of the order processing agents (136) to service the client devices (110) in accordance with the functionality of the order processing system (130) discussed throughout this disclosure. The agent deployment manager (132) may make determinations for when to boot up the order processing agents (136), when to assign each of the processing agents (136) on standby, and/or when to reduce the number of processing agents (136) providing the services of the order processing system (130). Further, the agent deployment manager (132) may initiate the booting or powering down of the processing agents (136) in accordance with the aforementioned determinations.

To make such determinations, the agent deployment manager (132) may utilize the functionality of the order forecasting manager (134). While illustrated as a separate entity, the order forecasting manager (134) may be a component of the order processing system (130) without departing from the invention. The order forecasting manager (134) may include functionality for generating order forecasts for a given period of time. The order forecasts may be generated as forecasting sequences which may be represented as, for example, graphical Fourier transform. The forecasting sequences may represent outputs of an expected volume of orders for a point in time. In one or more embodiments, the expected volume of orders for a point in time may be an estimated average number of orders that an epicenter of a corporate entity is predicted to process over a predefined period of time (e.g., a week). In one or more embodiments, an epicenter of a corporate entity is a logical partitioning of entities within the corporate entity based on factors such as geographical regions in which the entities of the corporate entity operate. The entities may be, for example, employees and the computing devices used by the employees to provide the services (or enable the computing devices to provide said services) of the order processing system (130).

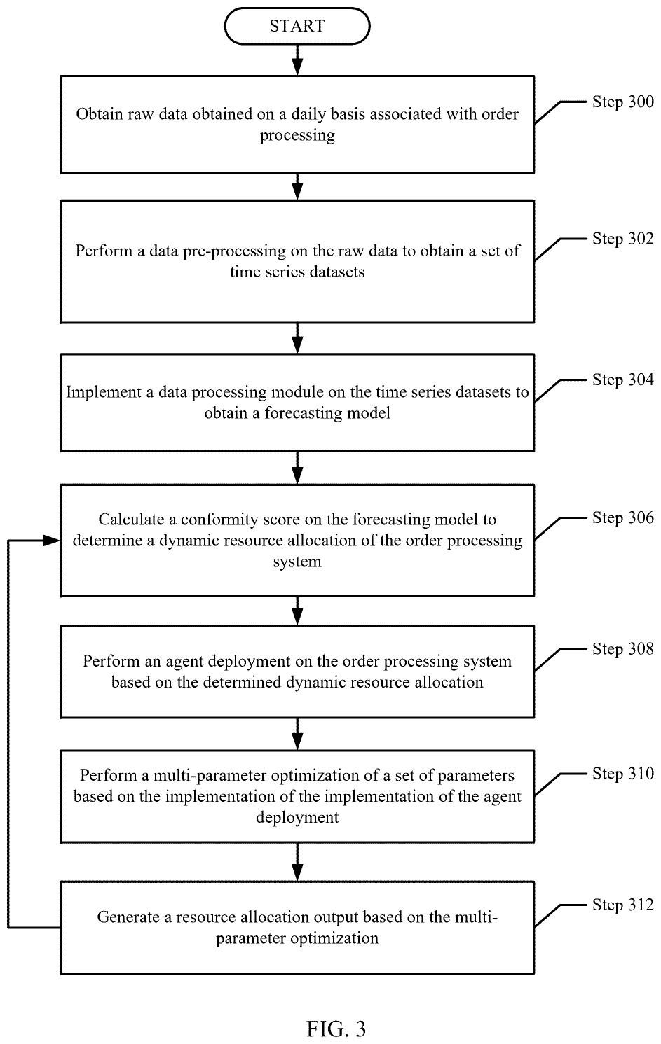

In one or more embodiments, the order forecasting manager (134) performs the generation of the forecasting models using the methods described in FIG. 3. The order forecasting manager (134) may perform other methods to generate the forecasting models in accordance with one or more embodiments of the invention.

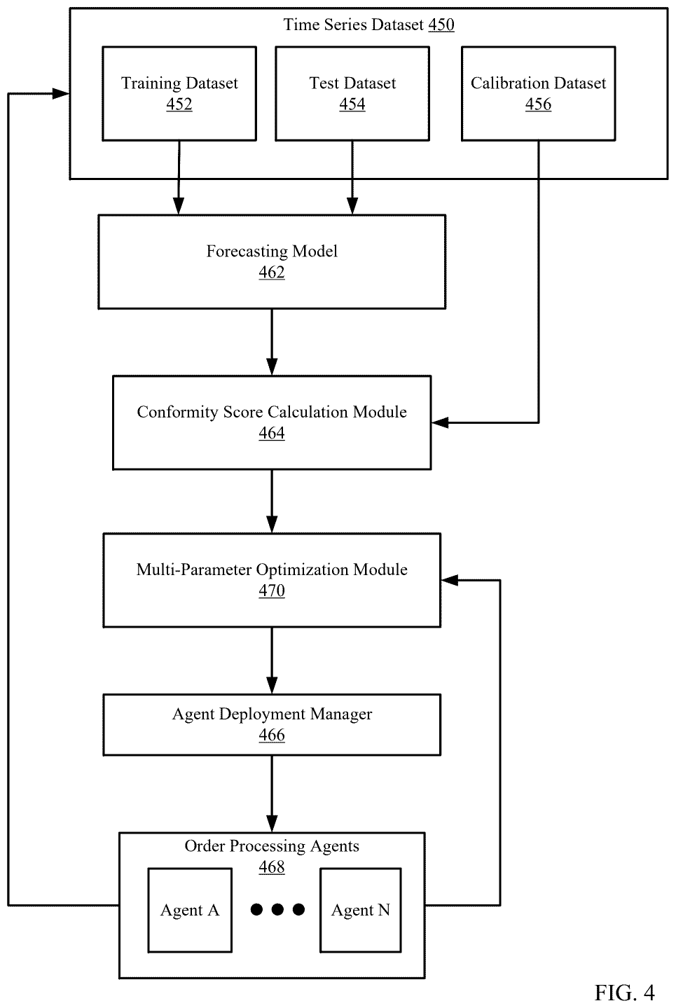

In one or more embodiments of the invention, the order forecasting manager (134) (and/or any components within) may be implemented as one or more computing devices (e.g., 400, FIG. 4). A computing device may be, for example, a mobile phone, a tablet computer, a laptop computer, a desktop computer, a server, a sale terminal, a distributed computing system, or a cloud resource such as a transaction management unit. The computing device may include one or more processors, memory (e.g., RAM), and persistent storage (e.g., disk drives, SSDs, etc.). The computing device may include instructions, stored on the persistent storage, that when executed by the processor(s) of the computing device cause the computing device to perform the functionality of the order forecasting manager (134) (and/or any components within) described throughout this present disclosure including, for example, the method illustrated in FIG. 3.

Alternatively, in one or more embodiments of the invention, the order forecasting manager (134) (and/or any components within) may be implemented as logical devices. A logical device may utilize the computing resources of any number of computing devices to provide the functionality of the order processing system (130) (and/or any components illustrated within) described throughout this present disclosure including, for example, the method illustrated in FIG. 3.

In one or more embodiments of the invention, the above-mentioned system (100) components may operatively connect to one another through a network (120) (e.g., a local area network (LAN), a wide area network (WAN), a mobile network, a wireless LAN (WLAN), etc.). In one or more embodiments, the network (120) may be implemented using any combination of wired and/or wireless connections. The network (120) may encompass various interconnected, network-enabled subcomponents (not shown) (e.g., switches, routers, gateways, etc.) that may facilitate communications between the above-mentioned system (100) components.

In one or more embodiments of the invention, the network-enabled subcomponents may be capable of: (i) performing one or more communication schemes (e.g., Internet protocol communications, Ethernet communications, communications via any security protocols, etc.); (ii) being configured by the computing devices in the network (120); and (iii) limiting communication(s) on a granular level (e.g., on a per-port level, on a per-sending device level, etc.).

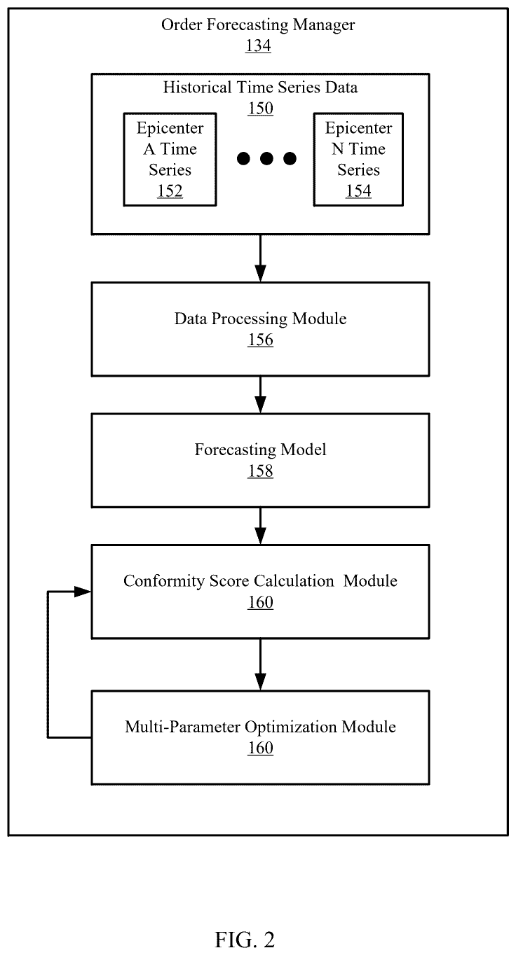

FIG. 2 shows a diagram of an order forecasting manager (134) in accordance with one or more embodiments. In one or more embodiments, the order forecasting manager (134) obtains historical time series data (150) from, for example, the order processing system (130, FIG. 1). The historical time series datasets (150) (also referred to as time series datasets or historical datasets) may specify a relationship between points in time and the corresponding number of orders for a period of time.

In one or more embodiments, each time series dataset (152, 154) is associated with an epicenter. As discussed above, an epicenter of a corporate entity is a logical partitioning of entities within the corporate entity based on factors such as geographical regions in which the entities of the corporate entity operate. The epicenters may each track their order processing information (e.g., number of orders for a given point in time) and provide an epicenter time series dataset (152, 154) to be used for the order forecasting models.

In one or more embodiments, to generate the outputted forecasting models, the historical time series data (150) may be processed using a data processing module (156), a conformity score calculation model (160) and a multi-parameter optimization module (162). In one or more embodiments, the data processing module (156) is a processing component that implements an artificial intelligence (AI) algorithm used to generate the forecasting model (158). The forecasting model (158) is applied to the conformity score calculation module (160). In one or more embodiments, the conformity score calculation module (160) includes calculating conformity scores for at least a portion of the historical time series data (150) in accordance with the method of FIG. 3 discussed below. The conformity score calculation may be calculated via other methods without departing from the invention.

In one or more embodiments, the forecasting model (158) may be further processed using a multi-parameter optimization module (162) that modifies parameters of the forecasting model (158) based on selected parameters to be optimized and using the calculated conformity scores. The multi-parameter optimization module (162) may perform the aforementioned functionality via the method of FIG. 3. The multi-parameter optimization performed by the multi-parameter optimization module (162) may result in a modified forecasting model (158). The modified forecasting model (158) may be used for agent deployments in accordance with FIGS. 3-4. The implementation of the agent deployments may be used in addition to the calculated conformity scores to further improve the forecasting model (158).

FIG. 3 shows a flowchart of a method of generating forecasting models in accordance with one or more embodiments of the invention. The method shown in FIG. 3 may be performed by, for example, an order forecasting manager (e.g., 134, FIG. 1). Other components of the system in FIGS. 1-2 may perform all, or a portion, of the method of FIG. 3 without departing from the invention.

While FIG. 3 is illustrated as a series of steps, any of the steps may be omitted, performed in a different order, additional steps may be included, and/or any or all of the steps may be performed in a parallel and/or partially overlapping manner without departing from the invention.

Turning to FIG. 3, in step 300, raw data associated with order processing is obtained on a daily basis. In one or more embodiments, the raw data includes daily data points corresponding to order volumes serviced by the order processing system. The raw data may include data points each specifying a timestamp (e.g., a date), a number of orders for the corresponding timestamp, an epicenter, and any additional information without departing from the invention.

In step 302, a data pre-processing is performed on the raw data to obtain a time series dataset. In one or more embodiments, the data pre-processing includes performing an aggregation of the raw data to specify data points for time periods such as, for example, weeks and an aggregate number of orders serviced during each week.

In one or more embodiments, daily data may have sporadic patterns, null values and even missing values due to holidays and weekends. Given the sporadic nature of data obtained on a daily basis, data may be first rolled up to a weekly aggregate (with week ending, for example, on Friday). This process may enable latent repeating patterns to be exposed if applicable. In the case of order processing planning, weekly aggregated data may demonstrate repeating patterns, albeit with level shifts, exist as opposed to in daily aggregated data. The resulting processed data is referred to as a time series dataset.

In step 304, a data processing module is implemented on the time series dataset to obtain a forecasting model. In one or more embodiments, implementing the data processing module includes partitioning the time series dataset into training, test and calibration datasets. Any forecast algorithm or transformer based algorithm may be used as the AI algorithm to forecast order volumes N steps ahead. The forecasting model is trained using training data and validated on the test data. Calibration data is used for conformal prediction as discussed in step 306. The partitioning of the time series dataset may be performed using any percentages of the time series dataset without departing from the invention. An example partitioning may include 50% of the time series dataset being assigned to the training dataset, 30% of the time series dataset assigned to the test dataset, and 20% of the time series dataset assigned to the calibration dataset.

In step 306, a conformity score is calculated for the forecasting model to determine a dynamic resource allocation of the order processing system. In one or more embodiments, the conformity score provides a quantitative measure of how well a new observation aligns with a set of previously observed data. Said another way, it gauges a fit of a new data point within the context of known data. A high conformity score indicates that the new observation is relatively consistent with historical patterns of the known data, while a low score suggests it may be an outlier or anomaly compared to the known data. The known data may be the data of the test dataset or the training dataset. The new data points may be data points of the calibration dataset.

To provide clarification of the conformity score calculation, consider f as a function that measures the conformity of an observation. For a given observation xi in a set of previously observed data D (e.g., the training dataset), the conformity measure αi is given by the equation αi=ƒ (xi,D).

The function ƒ may vary based on the specific application and the nature of the data. For instance, in regression problems, ƒ might measure the deviation of xi from a predicted value. In classification, it might measure the confidence or probability of xi belonging to a particular class. Other functions may be used for f without departing from the invention. Following the calculation of the conformity measures for all observations, the conformity score for a new observation xnew of the calibration dataset may be determined. The new observation xnew may alternatively be a new data point obtained after the implementation of the agent deployment as discussed in step 308 below. The conformity score of xnew may be calculated by comparing its conformity measure anew with the conformity measures of the observations in D.

The conformity score CS for xnew is given by the equation CS(xnew)=1/N*sum(I(αi<αnew)), where:
N is the number of observations in D, and
I is the indicator function, which is 1 if the condition inside the parenthesis is true and 0 otherwise.

In one or more embodiments, the conformity score represents the proportion of observations in D that have a conformity measure less than or equal to that of xnew. In one or more embodiments, each conformity score ranges from 0 to 1, with values closer to 1 indicating higher conformity. The conformity score may provide a standardized way to assess the alignment of a new observation with historical data. By quantifying this alignment, the system may make informed decisions about resource allocation, ensuring that resources are deployed in a manner consistent with observed patterns and trends.

In step 308, an agent deployment is performed on the order processing system based on the determined dynamic resource allocation. In one or more embodiments, the agent deployment may be initiated such that the number of available agents for an upcoming point in time is increased if the forecasting model indicates a larger number of orders. Further, the number of agents may be decreased for a future point in time in which the forecasting model indicates a relatively low number of orders for the upcoming point in time.

In one or more embodiments, the agent deployment is implemented using a dynamic resource allocation decision. In one or more embodiments, the dynamic resource allocation decision is a process by which resources are assigned or distributed based on the conformity score and other relevant parameters. The goal of implementing the dynamic resource allocation decision may be to ensure that resources are optimally utilized, minimizing both wastage and the risk of missed opportunities. The system dynamically adjusts the allocation of resources in response to the conformity score of new data, ensuring that resources are judiciously deployed in sync with prevailing conditions.

Let's denote R as the total available resources (e.g., a total number of order processing agents available for deployment on a given week) and A(x) as the allocation function for a new observation x. The function A determines how much of R should be deployed based on the conformity score CS and possibly other parameters. Using this, the below equation is applied:

$$A ( x ) = g ( C S ( x ) , R , θ ) ,$$

where:
g is the resource allocation function, and
θ represents other parameters or constraints that might influence the allocation. Such parameters may include, for example, minimum or maximum allocation limits, business rules, or other operational constraints. Other parameters may be represented using θ without departing from the invention.

In one or more embodiments, the allocation function g is designed to adjust dynamically based on CS. For instance, if CS is high (indicating high conformity with historical data), the allocation might be aggressive. Conversely, if CS is low (indicating potential anomaly or outlier), the allocation might be conservative.

A simple linear model might look like: A(x)=β0+β1×CS(x)×R, where:
β0 is the base allocation irrespective of the conformity score, and
β1 determines the sensitivity of the allocation to changes in the conformity score.

In practice, the allocation function is more complex, incorporating multiple parameters. For instance, there's a business rule that dictates a minimum allocation regardless of the conformity score, the function include a constraint: A(x)≥Rmin, where Rmin is the minimum required allocation.

The order processing manager may monitor the outcomes of its allocation decisions. If the actual outcomes deviate significantly from predictions, the parameters of the allocation function (like β0 and β1 in the linear model) might be adjusted to improve future allocations.

In one or more embodiments, the dynamic resource allocation decision discussed throughout step 308 ensures that resources are allocated in a manner that's both data-driven and adaptable. By adjusting allocations based on the conformity score and other parameters, the system ensures optimal resource utilization in a variety of scenarios.

In step 310, a multi-parameter optimization is performed on a set of parameters of the forecasting model and based on the agent deployment. In one or more embodiments, the multi-parameter optimization is a process of fine-tuning multiple variables or parameters simultaneously to achieve a desired outcome, such as maximizing efficiency or minimizing costs. In the context of embodiments of this invention discussed herein, it refers to the system's ability to consider various factors (including the conformity score) to optimize resource allocation decisions. The goal is to ensure that resources are utilized in the most efficient manner, taking into account multiple constraints and objectives.

In one or more embodiments, consider denoting O(p) as an objective function that the system aims to optimize, where p is a vector of parameters. This function represents the outcome (e.g., efficiency, cost, or performance) based on the current parameter values. The equation for the objective function is denoted as follows: O(p)=h(p1, p2, . . . , pn), where:
h is the function that describes the relationship between the parameters and the outcome, and
p1, p2, . . . , pn are the individual parameters. There are constraints that the solution must satisfy. These constraints may be represented as:

$$ci ( p ) \leq 0$$

$$dj ( p ) = 0$$

Where:
ci are inequality constraints.
dj are equality constraints.

The multi-parameter optimization may be formally stated as: Minimize O(p), Subject to: ci(p)≤0 and dj(p)=0.

In one or more embodiments various optimization algorithms may be employed to solve this problem, such as gradient descent, genetic algorithms, or other optimization algorithms without departing from the invention. The choice of optimization algorithm may depend on the nature of the objective function, the constraints, and the specific application.

In one or more embodiments, the conformity score CS may be one of the parameters in p or can influence the objective function directly. For instance, the objective function might be weighted by CS to give more importance to observations that align closely with historical data. An example equation is as follows: O(p)=CS×h(p1, p2, . . . , pn).

In one or more embodiments, as new data becomes available and the system learns more about its environment, the multi-parameter optimization can be iteratively refined. This may ensure that the system remains adaptive and continues to make optimal decisions as conditions change.

In step 312, a resource allocation output is generated based on the multi-parameter optimization. In one or more embodiments, the output generation and reporting is a process in which the system consolidates its findings, decisions, and insights into a structured format, making it accessible and interpretable for stakeholders of the order processing system such as managers or owners of the order processing system. For example, consider denoting O(p,D) as the output function, where p represents the parameters or decisions made by the system, and D represents the input data. As such, the equation is: O(p,D)=f(p,D), where: f is a function that transforms the decisions and data into a structured output. The output often includes various metrics or key performance indicators (KPIs) that quantify the results. Common metrics might include: conformity score average CSA=N1 Σ from 1 to N (CSi), where CSi is the conformity score of the ith observation.

Following the output generation of step 312, a feedback loop and self-learning process may be implemented to obtain updated parameters prior to returning to step 306. In one or more embodiments, the feedback loop and self-learning process is a continuous process where the system evaluates the outcomes of its decisions against the expected results. Any discrepancies or deviations are used to refine and adjust the strategies, ensuring that it becomes more accurate and effective over time. This iterative process allows the system to adapt to changing conditions and learn from its past actions.

In one or more embodiments, consider denoting F(y,y\hat{ }) as the feedback function, where y represents the actual outcome and y\hat{ } represents the predicted outcome based on the system's decisions: F(y,y\hat{ })=e(y−y\hat{ }), where:
e is a function that calculates the error or discrepancy between the actual and predicted outcomes.

The error is quantified using the relative error function: e=y|y−y\hat{ }|

Based on the feedback, the system adjusts its parameters. Let p be the vector of parameters, and Δp be the adjustments made based on the feedback, giving the following equation: pnew=pold+α×Δp, where:
α is a learning rate that determines the magnitude of adjustments. A smaller a results in gradual adjustments, while a larger a leads to more aggressive changes.

The parameters are adjusted in future iterations of steps 306-312 based on the feedback. The system may continuously monitors the outcomes of its decisions and compares them to predictions. This ongoing feedback loop may result in the system being adaptive and refining its strategies in real-time. The insights gained from the feedback loop may be incorporated into future iterations of the decision-making processes. In this manner, the system may learn from its past actions and becomes more effective over time.

To further clarify embodiments of the invention described throughout this disclosure, a non-limiting example is provided in FIG. 4.

### Example

Consider a scenario in which an order processing system for a business processes fluctuating and/or seasonally-based order volumes tracked each week. The order volumes are tracked as historical time series datasets.

FIG. 4 shows an example system in accordance with one or more embodiments of the invention. The example system illustrates the flow of data or other information using arrows between components of the example system. The components may be, for example, modules or data structures.

The example system includes a time series dataset (450) being processed in accordance with FIG. 3 to obtain three datasets: a training dataset (452), a test dataset (454), and a calibration dataset (456). In this example, the training dataset (452) and the test dataset (454) comprise 70% of the time series dataset (450) and are applied to an AI algorithm to obtain a forecasting model (462). The forecasting model (462) includes forecasting parameters. The calibration dataset (456), as such, comprises 30% of the time series dataset (450).

The forecasting model (462) and the calibration dataset are further processed using a conformity score calculation module (464). Conformity scores are generated from the calibration dataset (456) using the conformity score calculation module (464) in accordance with the method of FIG. 3. In this example, the following equation is applied to each data point in the calibration dataset (456): CS(xnew)=1/N*sum(I(αi<αnew)) as discussed in FIG. 3. The conformity scores for the calibration dataset (456) is compared to calculated conformity scores of new data (e.g., data points for later points in time).

The conformity scores are used to optimize the forecasting parameters using a multi-parameter optimization module (470) in accordance with the method of FIG. 3. Specifically, a formula is used to calculate a number of processing agents to be deployed on a given week to service order processing requests. In this example, the goal of the forecasting model (462) is ensuring that the actual number of agents are deployed each week (A) is as close as possible to the number of agents that expected to be required (R). For this, an optimization problem is set up in which the difference between the actual and required agent headcount is minimized subject to bounds and constraints. An objective function to be minimized is defined as follows: sum((R[i]−A[i])\hat{ }2). R is calculated based on the forecast of order volumes for the week (F), an array of constants (C), and variables (X1, X2, X3), which may serve as decision variables in the objective function. The conformity scores are used to create weights for the decision variables. This represents a penalty associated with the uncertainty of the forecast for that week calculated from the conformal prediction, as conformal prediction is said to provide validity to uncertainty quantification.

A set of finalized forecasting parameters are used to define the forecasting model (462). The forecasting model (462) is used by the agent deployment manager (466) to manage the deployment of order processing agents (468) for future order processing.

The implementation of the forecasting model (462) and the actual order volume is tracked. Information corresponding to the headcount and the actual order volume during the implementation and the expected order volume from the forecasting model (462) are input into the multi-parameter optimization module (470) as discussed above. Further, the information is further used to update the time series dataset (450) for future re-training of the forecasting model (462) and for future conformity score calculations and comparisons by the conformity score calculation module (464) as discussed above. Depending on how an architect of the order processing manager expects the variables to react to uncertainty, the architect may adjust the parameters for penalizing high or low conformity scores. For instances in which the conformity score carries a higher weight, an inverse transformation of the conformity score may be used as the weight, which may increase in value for low conformity scores. Otherwise, the conformity score may be used as the weight.

The above updating of the forecasting model (462) may be used to continue a cycle of implementing agent deployment in accordance with an updated forecasting model, and using information from the deployment to further update the forecasting model. In this manner, the forecasting model (462) improves in accuracy over time.

### End of Example

As discussed above, embodiments of the invention may be implemented using computing devices. FIG. 5 shows a diagram of a computing device in accordance with one or more embodiments of the invention. The computing device (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), input devices (510), output devices (508), and numerous other elements (not shown) and functionalities. Each of these components is described below.

In one embodiment of the invention, the computer processor(s) (502) may be an integrated circuit for processing instructions. For example, the computer processor(s) may be one or more cores or micro-cores of a processor. The computing device (500) may also include one or more input devices (510), such as a touchscreen, keyboard, mouse, microphone, touchpad, electronic pen, or any other type of input device. Further, the communication interface (512) may include an integrated circuit for connecting the computing device (500) to a network (not shown) (e.g., a local area network (LAN), a wide area network (WAN) such as the Internet, mobile network, or any other type of network) and/or to another device, such as another computing device.

In one embodiment of the invention, the computing device (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing devices exist, and the aforementioned input and output device(s) may take other forms.

Embodiments of the invention may provide a system and method for optimizing resource use for processing orders. Embodiments disclosed herein provide methods and systems for forecasting future orders and using the forecasts to manage the resources reserved for such orders. For high numbers of orders forecasted, embodiments disclosed herein enable preparation of these high numbers by preemptively deploying additional resources (e.g., agents) for handling the expected high number of orders. Conversely, for low numbers of orders, the number of resources reserved for order processing may be reduced, thus preserving the resource consumption of the order processing system.

Thus, embodiments of the invention may address the problem of limited computing resources in a distributed system. The problems discussed above should be understood as being examples of problems solved by embodiments of the invention of the invention and the invention should not be limited to solving the same/similar problems. The disclosed invention is broadly applicable to address a range of problems beyond those discussed herein.

One or more embodiments of the invention may be implemented using instructions executed by one or more processors of a computing device. Further, such instructions may correspond to computer readable instructions that are stored on one or more non-transitory computer readable mediums.

While the invention has been described above with respect to a limited number of embodiments, those skilled in the art, having the benefit of this disclosure, will appreciate that other embodiments can be devised which do not depart from the scope of the invention as of the invention. Accordingly, the scope of the invention should be limited only by the attached claims.

What is claimed is:

1. A method for managing order processing, the method comprising:
obtaining a time series dataset associated with the order processing for an order processing system;
generating a forecasting model for the time series dataset using a data processing module;
calculating a conformity score on the forecasting model to determine a dynamic resource allocation of the order processing system;
performing an agent deployment for a plurality of agents of the order processing system based on the dynamic resource allocation, wherein the plurality of agents each provide services associated with order processing;
performing a multi-parameter optimization of a set of parameters of the forecasting model based on the agent deployment to obtain an updated forecasting model; and
generating a resource allocation output based on the updated forecasting model, wherein the resource allocation output comprises a number of agents to be deployed for a second agent deployment.

2. The method of claim 1, further comprising applying a weekly aggregation on raw data to obtain the time series dataset, wherein the raw data comprises daily data points associated with the order processing.

3. The method of claim 1, wherein the data processing module partitions the time series dataset into a training dataset, a test dataset, and a calibration dataset.

4. The method of claim 3, wherein the forecasting model is based on the training dataset, and wherein the forecasting model is validated using the test dataset.

5. The method of claim 4, wherein the conformity score is generated by applying a function to data points of the forecasting model and data points of the calibration dataset.

6. The method of claim 1, wherein the updated forecasting model indicates a high number of orders during a future period in time, and wherein performing the agent deployment comprises increasing a number of agents of the plurality of agents for order processing during the future period in time.

7. The method of claim 1, wherein the updated forecasting model indicates a low number of orders during a future period in time, and wherein performing the agent deployment comprises decreasing a number of agents of the plurality of agents for order processing during the future period in time.

8. A non-transitory computer readable medium comprising computer readable program code, which when executed by a computer processor enables the computer processor to perform a method for managing order processing, the method comprising:
obtaining a time series dataset associated with the order processing for an order processing system;
generating a forecasting model for the time series dataset using a data processing module;
calculating a conformity score on the forecasting model to determine a dynamic resource allocation of the order processing system;
performing an agent deployment for a plurality of agents of the order processing system based on the dynamic resource allocation, wherein the plurality of agents each provide services associated with order processing;
performing a multi-parameter optimization of a set of parameters of the forecasting model based on the agent deployment to obtain an updated forecasting model; and
generating a resource allocation output based on the updated forecasting model, wherein the resource allocation output comprises a number of agents to be deployed for a second agent deployment.

9. The non-transitory computer readable medium of claim 8, the method further comprising: applying a weekly aggregation on raw data to obtain the time series dataset, wherein the raw data comprises daily data points associated with the order processing.

10. The non-transitory computer readable medium of claim 8, wherein the data processing module partitions the time series dataset into a training dataset, a test dataset, and a calibration dataset.

11. The non-transitory computer readable medium of claim 10, wherein the forecasting model is based on the training dataset, and wherein the forecasting model is validated using the test dataset.

12. The non-transitory computer readable medium of claim 11, wherein the conformity score is generated by applying a function to data points of the forecasting model and data points of the calibration dataset.

13. The non-transitory computer readable medium of claim 8, wherein the updated forecasting model indicates a high number of orders during a future period in time, and wherein performing the agent deployment comprises increasing a number of agents of the plurality of agents for order processing during the future period in time.

14. The non-transitory computer readable medium of claim 8, wherein the updated forecasting model indicates a low number of orders during a future period in time, and wherein performing the agent deployment comprises decreasing a number of agents of the plurality of agents for order processing during the future period in time.

15. A system, comprising:
a processor; and
memory including instructions, which when executed by the processor, perform a method comprising:
applying a weekly aggregation on raw data to obtain a time series dataset, wherein the raw data comprises daily data points associated with order processing by an order processing system;
generating a forecasting model for the time series dataset using a data processing module;
calculating a conformity score on the forecasting model to determine a dynamic resource allocation of the order processing system;
performing an agent deployment for a plurality of agents of the order processing system based on the dynamic resource allocation, wherein the plurality of agents each provide services associated with order processing;
performing a multi-parameter optimization of a set of parameters of the forecasting model based on the agent deployment to obtain an updated forecasting model; and
generating a resource allocation output based on the updated forecasting model, wherein the resource allocation output comprises a number of agents to be deployed for a second agent deployment.

16. The system of claim 15, wherein the data processing module partitions the time series dataset into a training dataset, a test dataset, and a calibration dataset.

17. The system of claim 16, wherein the forecasting model is based on the training dataset, and wherein the forecasting model is validated using the test dataset.

18. The system of claim 17, wherein the conformity score is generated by applying a function to data points of the forecasting model and data points of the calibration dataset.

19. The system of claim 15, wherein the updated forecasting model indicates a high number of orders during a future period in time, and wherein performing the agent deployment comprises increasing a number of agents of the plurality of agents for order processing during the future period in time.

20. The system of claim 15, wherein the updated forecasting model indicates a low number of orders during a future period in time, and wherein performing the agent deployment comprises decreasing a number of agents of the plurality of agents for order processing during the future period in time.
